(19) United States
(12) Patent Application Publication
(10) Pub. No.: US 2014/0085183 A1
(43) Pub. Date: Mar. 27, 2014

(54) HEAD-MOUNTED DISPLAY APPARATUS AND CONTROL METHOD THEREOF

(71) Applicant: SAMSUNG ELECTRONICS CO., LTD., Suwon-si (KR)

(72) Inventor: Moon-sung NA, Yongin-si (KR)

(73) Assignee: SAMSUNG ELECTRONICS CO., LTD., Suwon-si (KR)

(21) Appl. No.: 13/868,549

(22) Filed: Apr. 23, 2013

(30) Foreign Application Priority Data
Sep. 23, 2012 (KR) 10-2012-0092628

(51) Int. Cl. G02B 27/01

(52) U.S. Cl. CPC G02B 27/0172
USPC 345/156

(57) ABSTRACT

A head-mounted display apparatus and control method are provided. The apparatus includes a display unit, a signal processing unit processing an image signal to display an image on the display unit, a shutter unit performing a shutter operation to allow selective transmission of external light for both eyes of a user, a camera detecting and taking an image of an external environment of the head-mounted display apparatus, and a controller maintaining transmission of the shutter unit transmitting external light at preset first transmittance when the image is displayed on the display unit, and adjusting the transmission of the shutter unit to second transmittance higher than the first transmittance if the camera detects an external device while the image is displayed on the display unit.

### CROSS-REFERENCE TO RELATED APPLICATIONS

This application is related to, and claims priority to, Korean Patent Application No. 10-2012-0092628, filed on Aug. 23, 2012 in the Korean Intellectual Property Office, the disclosure of which is incorporated herein by reference.

### BACKGROUND

1. Field

Exemplary embodiments relate to a head-mounted display apparatus worn on a user's head and a control method thereof, more particularly to a head-mounted display apparatus selectively controlling transmission of external light with respect to both eyes of a user based on an external environmental change, and a control method thereof.

2. Description of the Related Art

A display apparatus may be defined as a device which includes a display panel to display an image. The images may be displayed based on various formats of image signals/image data received from outside on the panel, which may be configured as a TV or a monitor. The display panel may be configured as a variety of display types, such as a liquid crystal display (LCD) panel and a plasma display panel (PDP), to be applied to diverse display apparatuses based on characteristics thereof. A display apparatus having 40 inches or more of a large-screen panel is available to many users.

Various types of display apparatuses are proposed as technology progresses, for example, a head-mounted display apparatus. The head-mounted display apparatus may be configured as a pair of glasses worn on a user's head. The head-mounted display apparatus may have, for example, a structure in which a pair of glasses covering both the left and right eyes of the user are supported by a frame mounted on the user's head. A processing module to process an image signal and a battery may be installed in the frame.

When displaying an image, the head-mounted display apparatus forms an image on the glasses covering both eyes of the user, so that the user perceives the image. Despite a comparatively small size, the head-mounted display apparatus forms an image close to the eyes of the user, thus enabling the user to perceive the image as a large-screen image.

### SUMMARY

Additional aspects and/or advantages will be set forth in part in the description which follows and, in part, will be apparent from the description, or may be learned by practice of the invention.

The foregoing and/or other aspects may be achieved by providing a head-mounted display apparatus including a display unit, a signal processing unit processing an image signal to display an image on the display unit, a shutter unit performing a shutter operation to allow selective transmission of external light for both eyes of a user, a camera detecting and taking an image of an external environment of the head-mounted display apparatus, and a controller maintaining transmission of the shutter unit transmitting external light at preset first transmittance when the image is displayed on the display unit, and adjusting the transmission of the shutter unit to second transmittance higher than the first transmittance if the camera detects an external device while the image is displayed on the display unit.

The controller may determine a model name of the electronic device by analyzing a shape of the electronic device taken by the camera and may acquire a pairing code corresponding to the determined model name so as to conduct pairing with the electronic device for controlling an operation of the electronic device.

The head-mounted display apparatus include a communication unit capable of communicating with an server, wherein the controller may acquire the pairing code from the server by connecting to the server through the communication unit and transmitting the determined model name to the connected server.

The head-mounted display apparatus may further including a user input unit, wherein the controller may transmit a control signal corresponding to a command input through the user input unit to the electronic device so that the operation of the electronic device is controlled by the input command.

The head-mounted display apparatus include a microphone detecting a sound, wherein the controller may analyze a preset voice instruction of the user input through the microphone and generates a control signal corresponding to the voice instruction.

The controller may analyze an arrangement and a relevant function of a user input interface installed in the electronic device when analyzing the shape of the electronic device. The controller may generate a control signal corresponding to the function of the user input interface and transmit the control signal to the electronic device when the camera detects that a motion by the user is made on the user input interface of the electronic device.

The controller may adjust the transmittance of the shutter unit when the electronic device is detected by the camera for a preset time.

The head-mounted display apparatus include a microphone detecting a sound, wherein the controller may adjust the transmittance of the shutter unit when a preset voice instruction of the user through the microphone is detected.

The controller may control the image to stay still or controls not to display the image when the camera detects the electronic device.

In accordance with an exemplary embodiment of the present invention, a control method of a head-mounted display apparatus including a display unit, a shutter unit performing a shutter operation to allow selective transmission of external light for both eyes of a user, and a camera detecting and taking an image of an external environment of the head-mounted display apparatus includes maintaining transmission of the shutter unit transmitting external light at preset first transmittance when the image is displayed on the display unit, and adjusting the transmission of the shutter unit to second transmittance higher than the first transmittance if the camera detects an external device while the image is displayed on the display unit.

The adjusting the transmittance of the shutter unit may include determining a model name of the electronic device by analyzing a shape of the electronic device taken by the camera, and acquiring a pairing code corresponding to the determined model name so as to conduct pairing with the electronic device for controlling an operation of the electronic device.

The acquiring the pairing code corresponding to the determined model name may include connecting to an server to transmit the determined model name to the connected server; and acquiring the pairing code corresponding to the determined model name from the server.

The adjusting the transmission of the shutter unit may include receiving a command input through a user input unit of the head-mounted display apparatus; and transmitting a control signal corresponding to the input command to the electronic device so that the operation of the electronic device is controlled by the input command.

The transmitting the control signal corresponding to the input command to the electronic device may include receiving a preset voice instruction of the user input through a microphone of the head-mounted display apparatus; and generating a control signal corresponding to the voice instruction by analyzing the voice instruction.

The determining the model name of the electronic device by analyzing the shape of the electronic device may include analyzing an arrangement and a relevant function of a user input interface installed in the electronic device when analyzing the shape of the electronic device; and generating a control signal corresponding to the function of the user input interface and transmitting the control signal to the electronic device when the camera detects that a motion by the user is made on the user input interface of the electronic device.

The adjusting the transmission of the shutter unit may include adjusting the transmittance of the shutter unit when the electronic device is detected by the camera for a preset time.

The adjusting the transmission of the shutter unit may include adjusting the transmittance of the shutter unit when a preset voice instruction of the user through a microphone of the head-mounted display apparatus is detected.

The adjusting the transmission of the shutter unit may include maintaining the image to stay still or not displaying the image when the camera detects the electronic device.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 illustrates a display apparatus according to an exemplary embodiment.

FIG. 2 illustrates a display apparatus according to an exemplary embodiment.

FIG. 3 illustrates an exemplary structure of an image displayed by a display unit in an exemplary display apparatus formed in an eye, e.g., left eye of a user.

FIG. 4 illustrates an exemplary display apparatus operates in synchronization with an external display apparatus.

FIG. 5 illustrates an exemplary process of an exemplary display apparatus controlling a shutter unit in image display mode.

FIG. 6 illustrates an exemplary screen when a camera in an exemplary display apparatus detects an electronic device.

FIG. 7 illustrates an exemplary process of pairing the display apparatus with an electronic device.

FIG. 8 illustrates a screen when a motion occurs by a user while a camera in an exemplary display apparatus detects an electronic device.

### DETAILED DESCRIPTION

Exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

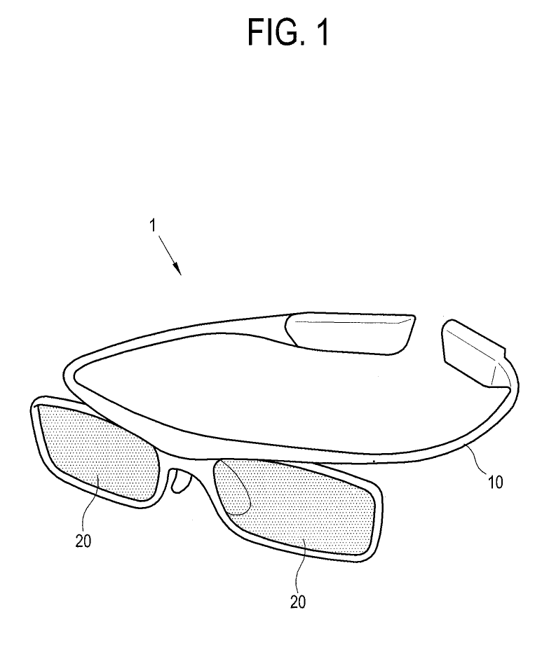

FIG. 1 illustrates a display apparatus 1 according to an exemplary embodiment.

As illustrated in FIG. 1, the display apparatus 1 according to an exemplary embodiment is a head-mounted display apparatus 1 mounted on a user's head. The display apparatus 1 may have a similar shape to a pair of glasses and includes a frame 10 configured to be put on the head or ears of a user and glass units 20 supported by the frame 10 and covering views of both left and right eyes of the user.

The frame 10 and the glass units 20 may be formed in various shapes with various materials, without being particularly limited. The frame 10 and the glass units 20 form an interior space to accommodate different elements of the display apparatus 1. The glass units 20 may be formed of a transparent material to enable light transmission.

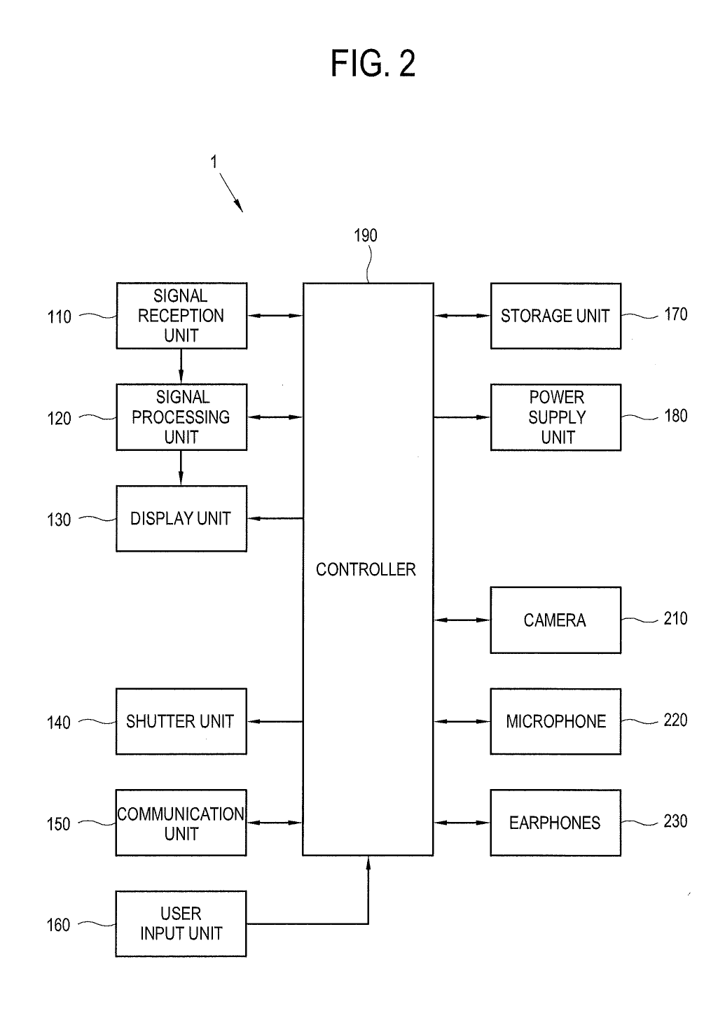

An exemplary configuration of the display apparatus 1 is described in detail with reference to FIG. 2.

FIG. 2 illustrates an exemplary display apparatus 1. Components of the display apparatus 1 illustrated in FIG. 2 may be accommodated in the frame 10 or the glass units 20 of FIG. 1. Accommodation forms or methods of these components change based on shapes of the frame 10 and the glass units 20 and do not limit the scope of an exemplary embodiment.

The elements of the display apparatus 1 illustrated in FIG. 2 are illustrative of an exemplary embodiment, but are not limited to the same.

As illustrated in FIG. 2, the display apparatus 1 includes a signal reception unit 110 receiving an image signal from the outside, a signal processing unit 120 processing an image signal received by the signal reception unit 110 according to a preset image processing process, a display unit 130 displaying an image based on the image signal processed by the signal processing unit 120, a shutter unit 140 conducting a shutter operation to allow selective transmission of external light for both eyes of a user, a communication unit 150 capable of communicating with various external devices (not illustrated), a user input unit 160 generating a preset control command by manipulation of the user, a storage unit 170 storing data, a power supply unit 180 supplying operating power to each component of the display apparatus 1, and a controller 1900 controlling operations, e.g., general operations of the display apparatus 1.

The display apparatus 1 may include a camera 210 taking/picking up a video/still image of an external environment, a microphone 220 detecting a sound of the external environment, and earphones 230 outputting the sound.

The signal reception unit 110 receives an image signal/image data transmitted from the outside via a wired, e.g., cable and/or wireless connection and transmits the signal/data to the signal processing unit 120 and/or the controller 190. For example, the signal reception unit 110 may receive a radio frequency (RF) signal transmitted from a broadcasting station (not illustrated) wirelessly or receive image signals in accordance with composite video, component video, super video, SCART, high definition multimedia interface (HDMI), DisplayPort, unified display interface (UDI), or wireless HD standards via a cable.

Although the signal reception unit 110 is described as a separate component from the communication unit 150 in the present embodiment, the signal reception unit 110 and the communication unit 150 may be integrated as a communication interface.

The signal processing unit 120 performs various image processing processes on an image signal received by the signal reception unit 110. The signal processing unit 120 outputs a processed image signal to the display unit 130, so that an image based on the image signal may be displayed on the display unit 130.

The signal processing unit 120 may perform various types of image processing processes, without being limited to, for example, decoding corresponding to an image format of image data, de-interlacing to convert an interlaced image signal into a progressive form, scaling to adjust image data to a preset resolution, noise reduction to improve image quality, detail enhancement, and frame refresh rate conversion.

The signal processing unit 120 may be provided as an integrated multi-functional component, such as a system on chip (SOC), or as an image processing board (not shown) formed by mounting components that independently conduct individual processes on a printed circuit board and be embedded in the display apparatus 1.

The display unit 130 displays an image based on an image signal processed by the signal processing unit 120 to be formed close to both eyes of the user. A configuration of the display unit 130 to display an image is described.

The shutter unit 140 conducts a shutter operation to selectively allow/block transmission of external light for at least one eye, e.g., both eyes of the user. The shutter unit 140 may be configured as liquid crystal shutter glass having light transmittance transmission adjusted by the controller 190 and is installed on an outside of the glass units 20 to cover both eyes of the user.

The shutter operation conducted by the shutter unit 140 may be selective with respect to each eye of the user or may operate in a similar manner with respect to both eyes of the user. For example, the shutter unit 140 may conduct a shutter operation such that light is blocked for the left eye of the user and light is transmitted for the right eye of the user. Alternatively, the shutter unit 140 may conduct a shutter operation such that light is blocked for the right eye of the user and light is transmitted for the left eye of the user. Alternatively, the shutter unit 140 may conduct a shutter operation such that light is blocked for both right and left eyes of the user or transmitted for both right and left eyes of the user. Alternatively, the shutter unit 140 may transmit or block light for both eyes of the user, adjusting transmission of the external light.

The communication unit 150 may perform bidirectional communications with various types of external devices (not illustrated) via a wired and/or wireless connection. The communication unit 150 may include a communication interface along with the signal reception unit 110 depending on a design. In an exemplary embodiment, the communication unit 150 may perform wireless communications based on bidirectional RF/wireless communication standard, such as RF and Bluetooth.

The user input unit 160 generates a preset control command and transmits the command to the controller 190 by manipulation of the user. For example, the user input unit 160 may be configured as an input key pad (not illustrated) installed on the frame 10 or a touch screen (not illustrated) or touch sensor (not illustrated) on the glass units 20.

The user input unit 160 may be configured as an external device (not illustrated), such as a remote controller separated from the display apparatus 1 or a mobile phone. The user input unit 160 may communicate with the communication unit 150 to transmit the control command to the controller 190.

The storage unit 170 stores unlimited data according to control of the controller 190. The storage unit 170 is configured as a nonvolatile memory, such as a flash memory and a hard disk drive. The storage unit 170 may be accessed by the controller 190, and the data stored in the storage unit 170 may be read/recorded/revised/deleted/updated by the controller 190.

The power supply unit 180 supplies power, e.g., direct-current (DC) power for operations of general components of the display apparatus 1. The power supply unit 180 may be configured as a primary battery or a secondary battery, for example, a secondary battery chargeable with an external power source for utilization. Power supply of the power supply unit 180 may be controlled by the controller 190, wherein, for example, whether to output power to a particular element, an output voltage level, and output duty adjustment are controlled.

The camera 210 may be installed on an outside of the frame 10 and detects and takes an image of an external environment of the display apparatus 1. The camera 210 may take an image of the external environment at particular time to generate a still image or take images of the external environment for a preset time to generate a video.

The camera 210 may monitor the external environment for a predetermined time. For example, when the user wearing the display apparatus 1 moves their eyes or turns their head, the camera 210 may newly detect an electronic device (not illustrated) in the external environment. The camera 210 informs the controller 190 that the electronic device 40 has been detected and transmits a still image/video of the detected electronic device 40 taken to the controller 190.

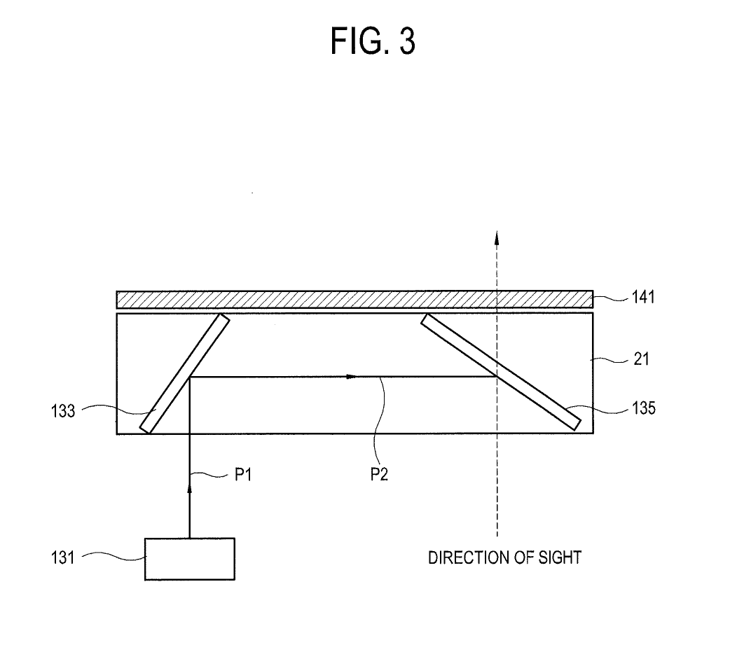

An exemplary structure of displaying an image on the display unit 130 is described with reference to FIG. 3.

FIG. 3 illustrates a structure of an image displayed by the display unit 130 being formed in an eye, e.g., the left eye of the user. Since a structure with respect to the left eye of the user and a structure with respect to the right eye of the user are substantially symmetrical on the display unit 130, an exemplary embodiment may be applied to the structure of an image being formed in the right eye of the user, and thus descriptions thereof are omitted herein.

As illustrated in FIG. 3, the display unit 130 includes a display element 131 presenting an image signal processed by the signal processing unit 120 as an image, a total reflection mirror 133 reflecting an image displayed on the display element 131, and a translucent mirror 135 on which an image reflected by the total reflection mirror 133 may be formed.

A left-eye shutter 141 covers an outside of a left-eye glass 21, thereby selectively controlling transmission of external light to the left eye of the user.

The display element 131 may be installed in the frame 10. The display element 131 may be configured as an LCD panel and displays an image by the signal processing unit 120.

The total reflection mirror 133 and the translucent mirror 135 may be installed in the left-eye glass 21 corresponding to the left eye of the user. The total reflection mirror 133 may be disposed in the left-eye glass 21 out of sight of the user and has total reflection characteristics to reflect an image displayed on the display element 131. The translucent mirror 135 may be disposed in a direction of sight of the user and has characteristics of transmitting part of entering light and forming the remaining entering light on the surface as an image.

When the left-eye shutter 141 allows light transmission and an image is not displayed on the display element 131, external light may arrive in the left eye of the user, passing through the left-eye shutter 141, the left-eye glass 21, and the translucent mirror 135. Thus, the user wearing the display apparatus 1 may perceive the external environment by the left eye.

When an image is displayed on the display element 131, the image displayed on the display element 131 enters the total reflection mirror 133 (P1). In this process P1, a lens (not illustrated) to adjust optical properties or an image transmission duct (not illustrated) to transmit an image, such as fiber, may be installed in the frame 10.

The image reflected by the total reflection mirror 133 may be formed on the translucent mirror 135 (P2). The image formed on the translucent mirror 135 may be perceived by the left eye of the user. When the left-eye shutter 141 is in a state of allowing light transmission, the user may perceive the external environment through the translucent mirror 135, with the image formed on the translucent mirror 135.

When it is not easy to perceive an image on the translucent mirror 135 by external light, the user may operate the left-eye shutter 141 to block light, thereby preventing interference by the external light.

In this way, the display apparatus 1 may display an image based on an image signal received from the outside or autonomously stored.

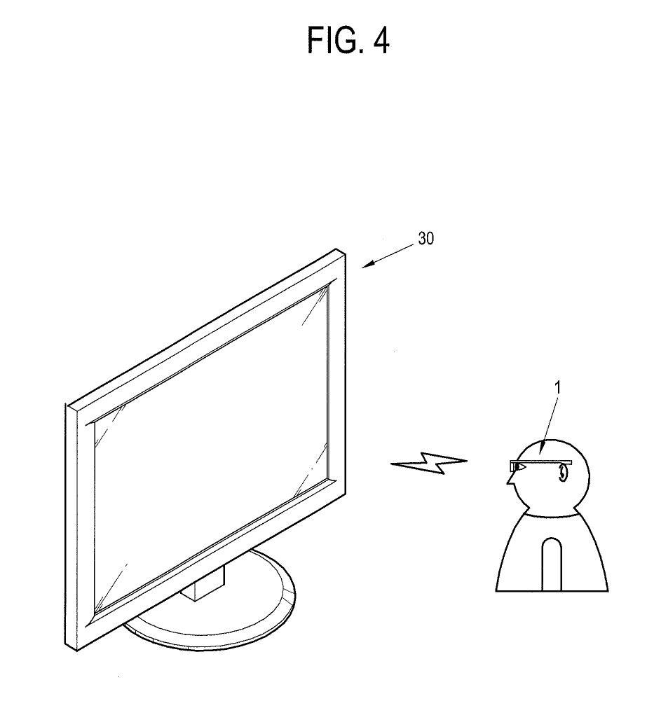

FIG. 4 illustrates an exemplary display apparatus of FIG. 1 operating in a synchronous mode, that is, operate in synchronization with an external display apparatus 30.

As illustrated in FIG. 4, the display apparatus 1 performs bidirectional communication with the external display apparatus 30, such as a TV, through the communication unit 150. When the display apparatus 1 and the external display apparatus 30 are paired with each other, various types of signals/data/information may be exchanged therebetween.

When the external display apparatus 30 displays an image, e.g., a three-dimensional (3D) image, the external display apparatus 30 alternately displays left-eye and right-eye images. The external display apparatus 30 generates a synchronization signal corresponding display cycle of the left-eye and right-eye images and transmits the synchronization signal to the display apparatus 1.

When the synchronization signal is received, the display apparatus 1 controls the shutter operation of the shutter unit 140 based on the received synchronization signal. The display apparatus 1 controls the shutter unit 140 to transmit light for the left eye of the user and to block light for the right eye of the user while a left-eye image is displayed on the external display apparatus 30. The display apparatus 1 may control the shutter unit 140 to block light for the left eye of the user and to transmit light for the right eye of the user while a right-eye image is displayed on the external display apparatus 30. While the left-eye or right-eye images are displayed as mixed on the external display apparatus 30, that is, the left-eye or right-eye images are scanned, the display apparatus 1 may control the shutter unit 140 to block light for both left and right eyes of the user.

The display apparatus 1 may control the display unit 130 to not display an image, or to display an image in another manner.

The display apparatus 1 according to an exemplary embodiment may operate in a mode among the synchronous modes in which the display apparatus 1 operates in accordance with a display cycle of external images displayed on the external display apparatus 30 and an image display mode in which the display apparatus 1 displays an image based on an image signal processed by the signal processing unit 120 on the display unit 130.

Selection of each mode may be realized by a control signal ordering to switch to a corresponding mode through the user input unit 160. Alternatively, the display apparatus 1 may automatically go to the synchronous mode, e.g., when paired with the external display apparatus 30. Alternatively, the display apparatus 1 may automatically go to the image display mode or a standby mode when released from pairing with the external display apparatus 30.

The standby mode may be defined variously and may be designated, for example, as allowing light transmission for both eyes of the user by the shutter unit 140 and not displaying an image on the display unit 130.

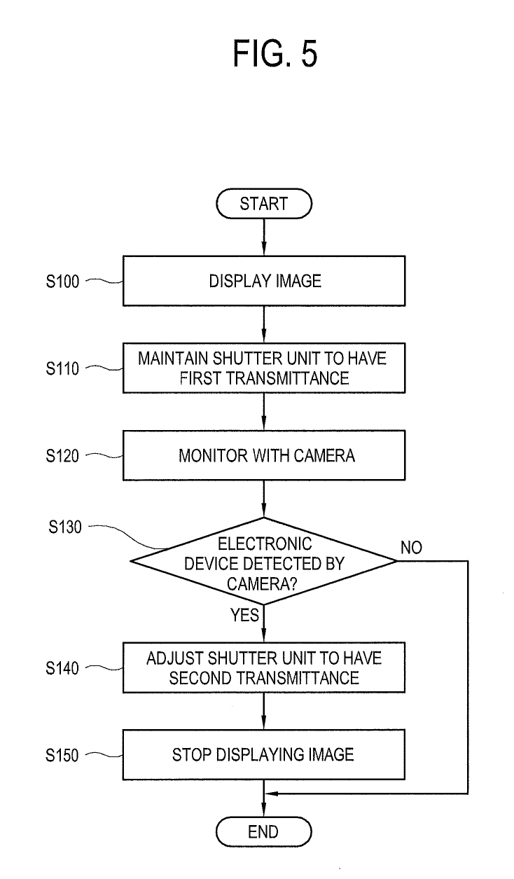

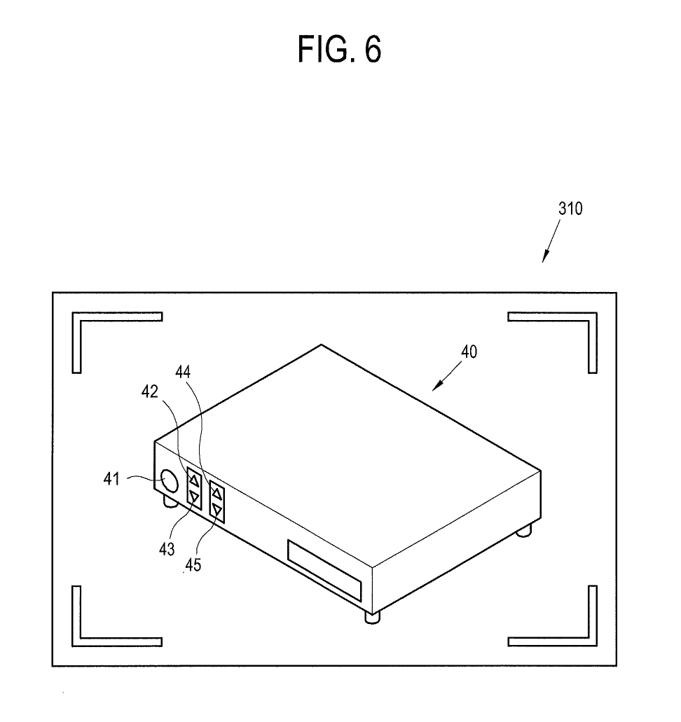

An operation of the camera 210 detecting the electronic device 40 when the display apparatus 1 is in the image display mode is described with reference to FIGS. 5 and 6. In an exemplary embodiment, the electronic device 40 may include a general electronic/electrical device, for example, a TV, a monitor, a set-top box, home appliances, a computer, and a mobile device.

FIG. 5 illustrates and exemplary process for the display apparatus 1 controlling the shutter unit 140 in the image display mode.

FIG. 6 illustrates a screen 310 when the camera 210 detects the electronic device 40.

As illustrated in FIGS. 5 and 6, while the display apparatus 1 operates in image display mode, the signal processing unit 120 processes an image signal to display an image on the display unit 130 (S100), and the shutter unit 140 maintains transmission of external light at preset first transmittance for both eyes of the user (S110).

The first transmittance is not limited to a particular value but may be changed variously within a range in which an external light blocking ratio is considered relatively high so that a general user easily perceive an image displayed on the display unit 130.

That is, the shutter unit 140 maintains the first transmittance while an image is displayed on the display unit 130, thereby suppressing interference by external light in both eyes of the user and enabling the user to easily perceive the image.

During the image display mode of the display apparatus 1, the camera 210 monitors an external environment (S120). Monitoring of the camera 210 may be automatically performed when the display apparatus 1 goes to the image display mode or be activated by input through the user input unit 160 or a voice instruction through the microphone 20 after the display apparatus 1 goes to the image display mode.

The camera 210 may detect a new electronic device 40 during monitoring, as illustrated in FIG. 6.

When the electronic device 40 is detected in the external environment (S130), the camera 210 transmits a detection result to the controller 190. When the electronic device 40 remains detected for a preset time, the camera 210 may transmit a detection result to the controller 190.

When the electronic device 40 is detected by the camera 20 (S130), the controller 190 adjusts light transmittance of the shutter unit 140 to second transmittance higher than the first transmittance (S140). That is, when the electronic device 40 is detected by the camera 210 as the user turns the head or moves the eyes while an image is displayed, the controller 190 controls light transmittance of external light through the shutter unit 140 to be relatively high.

The second transmittance is not limited to a particular value, but may be adjusted variously as long as the second transmittance is higher than the first transmittance.

The controller 190 controls the shutter unit 140 to have the second transmittance, and controls an image displayed on the display unit 130 to remain still or executes control so that an image is not displayed on the display unit 130 (S150).

Accordingly, the user wearing the display apparatus 1 may easily perceive the electronic device 40.

The controller 190 may adjust the transmittance of the shutter unit 140 using various methods, for example, a method of adjusting a level of driving voltage applied to the shutter unit 140 and a method of adjusting a duty width of driving voltage applied to the shutter unit 140.

In a method of adjusting the level of the driving voltage applied to the shutter unit 140, the shutter unit 140 includes the liquid crystal shutter glass. Transmittance of liquid crystals increases as a higher voltage is applied to the liquid crystals. Thus, the transmittance of the shutter unit 140 may increase when the level of the driving voltage is raised, while the transmittance of the shutter unit 140 may decrease when the level the driving voltage is reduced.

In a method of adjusting a duty width of the driving voltage applied to the shutter unit 140, defining time for which the liquid crystals are on based on voltage as duty, a longer duty width indicates a longer time the shutter unit 140 is open. A longer open time of the shutter unit 140 indicates a longer time light passes through the liquid crystals. Thus, the transmittance of the shutter unit 140 may increase with a longer duty width of the driving voltage, while the transmittance of the shutter unit 140 may decrease with a shorter duty width of the driving voltage.

Accordingly, the transmittance of the shutter unit 140 may be adjusted.

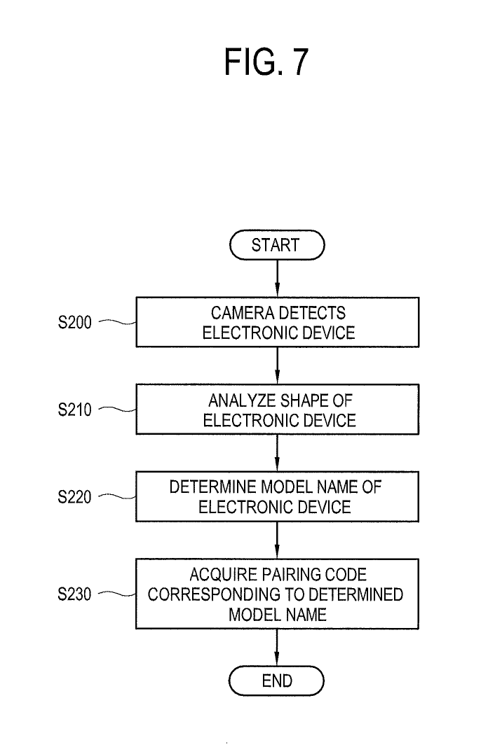

A process of pairing the display apparatus 1 with the electronic device 40 is described with reference to FIG. 7.

FIG. 7 illustrates an exemplary process of pairing the display apparatus 1 with an electronic device 40.

As illustrated in FIG. 7, when the camera 210 detects the electronic device 40 (S200), the controller 190 analyzes a shape of the electronic device 40 taken by the camera 210 (S210) to determine a model name of the electronic device 40 (S220). Various techniques and structures may be used to determine a model name of the electronic device 40 by shape analysis, without being particularly limited.

When various marks, for example, a bar code or a quick response (QR) code, to identify a model of the electronic device 40 are recognized from an image of the electronic device 40 taken by the camera 210, the controller 190 may determine the model name of the electronic device 40 based on a corresponding mark.

The controller 190 acquires a pairing code corresponding to the determined model name (S230), thereby pairing the electronic device 40 with the display apparatus 1. Pairing may be defined as a control operation of functionally combining the display apparatus 1 and the electronic device 40 so that both devices operate in synchronization or association. For example, when the display apparatus 1 and the electronic device 40 are paired, the display apparatus 1 may transmit a control signal ordering an operation of the electronic device 40 to the electronic device 40 so as to control the operation of the electronic device 40.

The controller 190 may use various methods to acquire the pairing code corresponding to the determined model name. For example, when a relational table of a model name and a pairing code is stored in the storage unit 170, the controller 190 accesses the relational table in the storage unit 170 to acquire a pairing code corresponding to a model name.

Alternatively, the controller 190 accesses an external server (not illustrated) through the communication unit 150 and transmits the determined model name to the server. The controller 190 may receive the pairing code corresponding to the model name from the server, thereby acquiring the pairing code.

When the display apparatus 1 and the electronic device 40 are paired through acquisition of the pairing code, it is possible to control an operation of the electronic device 40 through the display apparatus 1.

When the user inputs a predetermined command through the user input unit 160, the controller 190 transmits a control signal corresponding to the command to the electronic device 40 so that the operation of the electronic device 40 is controlled by the command. Accordingly, the electronic device 40 performs an operation corresponding to the received control signal.

When a voice instruction of the user is detected by the microphone 220, the controller 190 transmits a control signal corresponding to the voice instruction to the electronic device 40 so that the operation of the electronic device 40 is controlled by the voice instruction.

While analyzing the shape of the electronic device 40 to determine the model name of the electronic device 40 taken by the camera, the controller 190 may also analyze arrangements and relevant functions of various types of user input interfaces installed in the electronic device 40.

A user input interfaces is an input interface installed in the electronic device 40 for a user's input or manipulation and may be configured as various types, such as a key, a touch pad, and a touch screen.

An arrangement of a user input interface is information on where the user input interface is disposed in the electronic device 40 taken by the camera 210. A relevant function of a user input interface is information on an operation or function performed by the electronic device 40 when the user manipulates the user input interface.

As illustrated in FIG. 6, the controller 190 determines information on a type and a model name of the electronic device 40 through shape analysis of the electronic device 40. The controller 190 determines arrangements and relevant functions of user input interfaces 41, 42, 43, 44, and 45 installed in the electronic device 40 based on the determined information. For example, the controller 190 may determine that the electronic device 40 is a set-top box and the user input interfaces 41, 42, 43, 44, and 45 includes a power on/off button 41, a channel up button 42, a channel down button 43, a volume up button 44, and a volume down button 45.

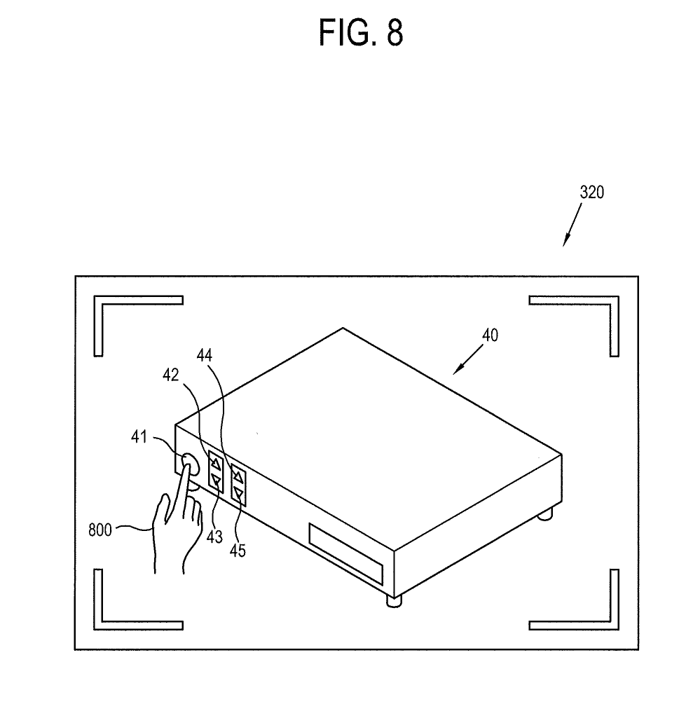

When the camera 210 detects and monitors the electronic device 40 and the controller 190 determines the model name of the electronic device 40 and the user input interfaces 41, 42, 43, 44, and 45, an action or motion 800 may occur by the user as illustrated in FIG. 8.

FIG. 8 illustrates a screen 320 when a motion 800 occurs by a user while the camera 210 detects the electronic device 40.

As illustrated in FIG. 8, a motion 800 of the user, for example, the user moving a fingertip or touching an interface with a fingertip, may be detected by the camera 210. The controller 190 may determine whether the motion 800 is made on the user input interfaces 41, 42, 43, 44, and 45 of the electronic device 40. The controller 190 generates a control signal corresponding to a function of a user input interface 41, 42, 43, 44, or 45 on which the motion 800 is made and transmits the control signal to the electronic device 40.

For example, FIG. 8 illustrates the motion 800 is made on the power on/off button 41 among the user input interface 41, 42, 43, 44, and 45. Accordingly, the controller 190 generates a control signal ordering a power on/off operation corresponding to a function of the power on/off button 41 and transmits the control signal to the electronic device 40.

The electronic device 40 receives the control signal and performs a power on/off operation in the same manner as when the user clicks the power on/off button 41.

When the motion 800 of the user is made on the volume up button 44, the controller 190 transmits a control signal ordering a volume up operation to the electronic device 40 so that the electronic device 40 performs the volume up operation corresponding to a function of the volume up button 44.

According to this process, the user wearing the display apparatus 1 may easily control the operation of the electronic device 40.

Although a few exemplary embodiments have been illustrated and described, it will be appreciated by those skilled in the art that changes may be made in these exemplary embodiments without departing from the principles and spirit of the invention, the scope of which is defined in the appended claims and their equivalents.

1. A head-mounted display apparatus comprising:
a display unit;
a signal processing unit processing an image signal to display an image on the display unit;
a shutter unit performing a shutter operation to allow selective transmission of external light for both eyes of a user;
a camera detecting and taking an image of an external environment of the head-mounted display apparatus; and
a controller maintaining transmission of the shutter unit transmitting external light at a preset first transmittance when the image is displayed on the display unit, and adjusting the transmission of the shutter unit to a second transmittance that is higher than the first transmittance if the camera detects an external device while the image is displayed on the display unit.

2. The head-mounted display apparatus of claim 1, wherein the controller determines a model name of the electronic device by analyzing a shape of the electronic device taken by the camera and acquires a pairing code corresponding to the determined model name so as to conduct pairing with the electronic device for controlling an operation of the electronic device.

3. The head-mounted display apparatus of claim 2, further comprising a communication unit capable of communicating with an server, wherein the controller acquires the pairing code from the server by connecting to the server through the communication unit and transmitting the determined model name to the connected server.

4. The head-mounted display apparatus of claim 2, further comprising a user input unit, wherein the controller transmits a control signal corresponding to a command input through the user input unit to the electronic device so that the operation of the electronic device is controlled by the input command.

5. The head-mounted display apparatus of claim 4, further comprising a microphone capable of detecting a sound, wherein the controller analyzes a preset voice instruction of the user input through the microphone and generates a control signal corresponding to the voice instruction.

6. The head-mounted display apparatus of claim 2, wherein the controller analyzes an arrangement and a relevant function of a user input interface installed in the electronic device when analyzing the shape of the electronic device, and generates a control signal corresponding to the function of the user input interface and transmits the control signal to the electronic device when the camera detects that a motion by the user is made on the user input interface of the electronic device.

7. The head-mounted display apparatus of claim 1, wherein the controller adjusts the transmittance of the shutter unit when the electronic device is detected by the camera for a preset time.

8. The head-mounted display apparatus of claim 7, further comprising a microphone capable of detecting a sound, wherein the controller adjusts the transmittance of the shutter unit when a preset voice instruction of the user through the microphone is detected.

9. The head-mounted display apparatus of claim 1, wherein the controller controls the image to stay still or controls not to display the image when the camera detects the electronic device.

10. A control method of a head-mounted display apparatus comprising a display unit, a shutter unit performing a shutter operation to allow selective transmission of external light for both eyes of a user, and a camera detecting and taking an image of an external environment of the head-mounted display apparatus, the control method comprising:
maintaining transmission of the shutter unit transmitting external light at a preset first transmittance when the image is displayed on the display unit; and
adjusting the transmission of the shutter unit to a second transmittance higher than the first transmittance if the camera detects an external device while the image is displayed on the display unit.

11. The control method of claim 10, wherein the adjusting the transmittance of the shutter unit comprises determining a model name of the electronic device by analyzing a shape of the electronic device taken by the camera; and acquiring a pairing code corresponding to the determined model name so as to conduct pairing with the electronic device for controlling an operation of the electronic device.

12. The control method of claim 11, wherein the acquiring the pairing code corresponding to the determined model name comprises connecting to an server to transmit the determined model name to the connected server; and acquiring the pairing code corresponding to the determined model name from the server.

13. The control method of claim 11, wherein the adjusting the transmission of the shutter unit comprises receiving a command input through a user input unit of the head-mounted display apparatus; and transmitting a control signal corresponding to the input command to the electronic device so that the operation of the electronic device is controlled by the input command.

14. The control method of claim 13, wherein the transmitting the control signal corresponding to the input command to the electronic device comprises receiving a preset voice instruction of the user input through a microphone of the head-mounted display apparatus; and generating a control signal corresponding to the voice instruction by analyzing the voice instruction.

15. The control method of claim 11, wherein the determining the model name of the electronic device by analyzing the shape of the electronic device comprises analyzing an arrangement and a relevant function of a user input interface installed in the electronic device when analyzing the shape of the electronic device; and generating a control signal corresponding to the function of the user input interface and transmitting the control signal to the electronic device when the camera detects that a motion by the user is made on the user input interface of the electronic device.

16. The control method of claim 10, wherein the adjusting the transmission of the shutter unit comprises adjusting the transmittance of the shutter unit when the electronic device is detected by the camera for a preset time.

17. The control method of claim 16, wherein the adjusting the transmission of the shutter unit comprises adjusting the transmittance of the shutter unit when a preset voice instruction of the user through a microphone of the head-mounted display apparatus is detected.

18. The control method of claim 10, wherein the adjusting the transmission of the shutter unit comprises maintaining the image to stay still or not displaying the image when the camera detects the electronic device.

19. (canceled)

20. (canceled)
